(19) United States
(12) Patent Application Publication
(10) Pub. No.: US 2016/0039634 A1
(43) Pub. Date: Feb. 11, 2016

(54) ELEVATOR CONTROL PANEL, AND AN ELEVATOR

(71) Applicant: KONE Corporation, Helsinki (FI)

(72) Inventors: Ari VARELIUS, Espoo (FI); Jari KANTOLA, Sajaniemi (FI); Juha PANULA, Hameenlinna (FI)

(73) Assignee: KONE CORPORATION, Helsinki (FI)

(21) Appl. No.: 14/885,526

(22) Filed: Oct. 16, 2015

Related U.S. Application Data
(63) Continuation of application No. PCT/FI2014/050327, filed on May 5, 2014.

(30) Foreign Application Priority Data
May 6, 2013 (FI) 20135466

(51) Int. Cl. B66B 1/34

(52) U.S. Cl. CPC B66B 1/3423

(57) ABSTRACT

An elevator control panel and an elevator including the elevator control panel are provided. The elevator control panel has an input, via which the main circuit of the elevator is brought to the control panel, and an output, via which the main circuit of the elevator is taken onwards out of the control panel. The control panel includes a main switch, which is connected to the main circuit of the elevator for disconnecting/energizing the main circuit leaving from the control panel. The control panel also includes a bent busbar, which is connected to the main circuit of the elevator, in series with the aforementioned main switch.

### FIELD OF THE INVENTION

The invention relates to the placement and wiring of components in an elevator control panel.

### BACKGROUND OF THE INVENTION

An elevator has a main circuit, via which electric power is supplied to the various electrical devices of the elevator. The electricity supply to the main circuit of the elevator occurs from the main supply of the building via the main switch. The electrical devices of the elevator are de-energized by disconnecting the current of the main circuit manually at the main switch. Current disconnection can also be performed e.g. in connection with installation work and servicing work on the elevator. After the installation work/servicing work is finished, the elevator is taken back into use by switching, at the main switch, current to the main circuit of the elevator.

Since the main switch is needed, inter alia, during installation and servicing, it is endeavored to situate the main switch in such a way that the personnel servicing the elevator are able to access it easily. A problem in modern elevators without machine room, and particularly in high-powered elevators, is a lack of space, owing to which it is difficult to find a suitable location for a large-sized main switch and for the thick supply cables of the main circuit of the elevator that are to be connected to it. One possibility is to locate the main switch and the supply cables in the elevator hoistway. This, however, hampers installation work and servicing work, because a serviceman must then repeatedly visit the elevator hoistway to use the main switch. Unnecessarily repetitive visits to the elevator hoistway can also be a safety risk from the viewpoint of installation work and servicing work.

### AIM OF THE INVENTION

One aim of the invention is to disclose an improvement for the space problem of the main switch and supply cables of the main circuit.

To achieve this aim the invention discloses an elevator control panel according to claim 1 and also an elevator according to claim 11. The preferred embodiments of the invention are described in the dependent claims. Some inventive embodiments and inventive combinations of the various embodiments are also presented in the descriptive section and in the drawings of the present application.

### SUMMARY OF THE INVENTION

The elevator control panel according to the invention has an input, via which the main circuit of the elevator is brought to the control panel, and an output, via which the main circuit of the elevator is taken onwards out of the control panel. The control panel comprises a main switch, which is connected to the main circuit of the elevator for disconnecting/energizing the main circuit leaving from the control panel. The control panel also comprises a bent busbar, which is connected to the main circuit of the elevator, in series with the aforementioned main switch. The aforementioned main switch is preferably a manually-operated main switch. By means of the series circuit of the bent busbar and the main switch, the current path of the main circuit of the elevator can be turned in a smaller space than what is known in the art (i.e. in a smaller space than the minimum permitted bending radius of the supply cables), in which case the elevator control panel can also be designed to be of a smaller size than prior art.

In one preferred embodiment of the invention the aforementioned busbar is configured to turn the current path of the main circuit of the elevator 180 degrees in the control panel. In this case the cables of the incoming and outgoing main circuit can be disposed close together in the control panel, e.g. in such a way that the cables are situated one above another on the base of the control panel. The control panel can also in this case easily be made to be elongated, comprising a base as well as two shorter and two longer side walls facing each other, and the input and output of the main circuit of the elevator can also be situated on the same shorter side wall of the control panel. This type of elongated control panel is advantageous because it can be easily situated on an elevator landing in the frame of a door of the elevator hoistway or in the immediate proximity of the frame. A control panel situated on a landing is also easily accessible to a serviceman.

In one preferred embodiment of the invention the aforementioned busbar is a U-rail. By means of the U-shaped busbar, the current path of the main circuit of the elevator can be turned 180 degrees in a very small space.

In one preferred embodiment of the invention the busbar is coated with electrical insulation. This means that the insulation distance required for a live busbar decreases, in which case the busbar can be situated close to other components in the control panel.

The electrical insulation used can be e.g. plastic, rubber or ceramic material, i.e. dielectric material, which resists an external electrical field.

In one preferred embodiment of the invention the electrical insulation is laminated onto the surface of the busbar. Lamination is a fast and reliable method of fabricating an insulated busbar according to the invention.

In one preferred embodiment of the invention the control panel has an openable lid, via which the main switch can be accessed. In this case a serviceman easily accesses, via the openable lid, the manually-operated main switch, which facilitates and speeds up installation work and servicing work. In one preferred embodiment of the invention the openable lid can also be locked.

In one preferred embodiment of the invention the control panel has a separate busbar per each phase of the main circuit of the elevator, and each aforementioned busbar is connected, in series with the aforementioned main switch, to a different phase of the main circuit of the elevator. In some embodiments the aforementioned separate busbars are replaced with an integrated rail comprising parallel conductor rails, electrically insulated from each other, per each phase of the main circuit of the elevator.

In one preferred embodiment of the invention both the main switch and the busbars have connection terminals, and each connection terminal of the output side of the main switch is connected to the connection terminal of the input side of the busbar. Each busbar is bent to travel under the main switch in such a way that the connection terminal of the output side of each busbar is disposed on the same side of the main switch as the connection terminals of the input side of the main switch. The cables of the main circuit arriving in the control panel are preferably connected to the connection terminals of the input side of the main switch, and the cables of the main circuit leaving the control panel are connected to the connection terminals of the output side of the busbars. This means that the cables of the main circuit arriving in the control panel and also the cables of the main circuit leaving the control panel are accessible from the same side of the main switch and they can also be taken, without bending the cables, to inputs and to outputs situated on the same side wall of the control panel.

The second aspect of the invention relates to an elevator, which comprises a control panel according to the description. The control panel according to the invention can be designed to be smaller in size than prior art, which facilitates placement of the control panel, particularly in modern elevators without machine room and especially in connection with high-powered elevators, i.e. those lifting a heavy load and/or traveling at high speeds.

In one preferred embodiment of the invention the elevator is an elevator without machine room. The control panel according to the invention can be situated in an elevator without machine room on a landing, e.g. in a frame of a hoistway door or in a point in the immediate proximity of the frame, where it is easily accessible.

The preceding summary, as well as the additional features and additional advantages of the invention presented below, will be better understood by the aid of the following description of some embodiments, said description not limiting the scope of application of the invention.

### BRIEF EXPLANATION OF THE FIGURES

FIG. 1 presents a diagrammatic view of one control panel according to an embodiment of the invention fitted into the frame of a door of the elevator hoistway on the landing side.

FIG. 2 presents the series circuit of the main switch and a busbar in the control panel of FIG. 1.

FIG. 3 presents the series circuit of the main switch and the busbar of FIG. 2 as viewed from a second direction.

FIG. 4 presents the series circuit of the main switch and the busbar of FIGS. 2 and 3 as viewed from a third direction.

### MORE DETAILED DESCRIPTION OF PREFERRED EMBODIMENTS OF THE INVENTION

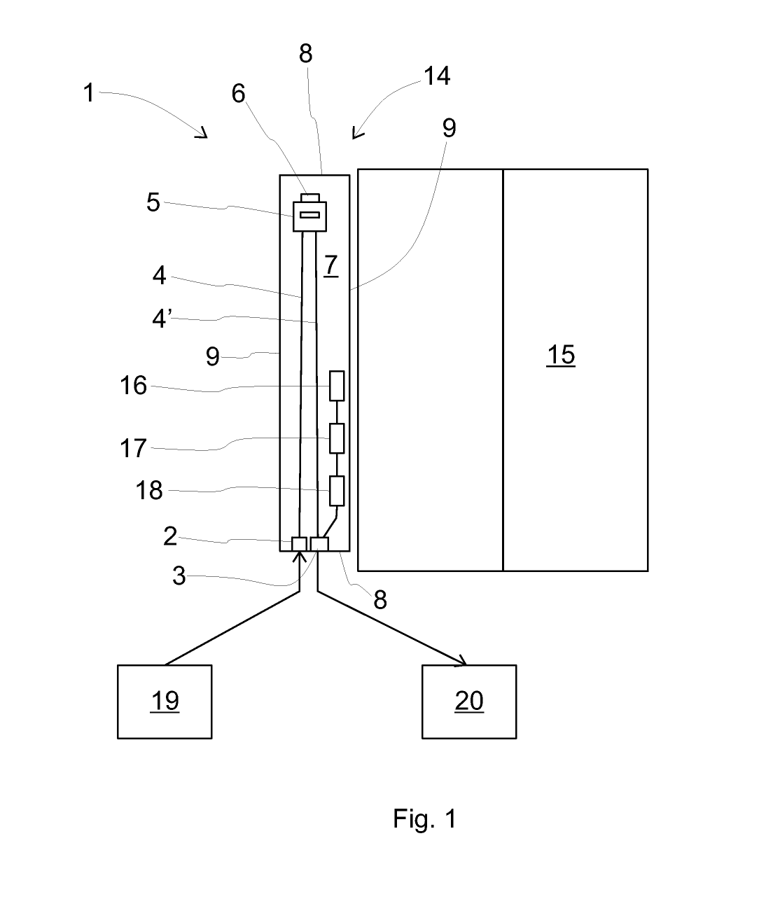

FIG. 1 presents a view of an elevator without machine room from a landing of the elevator. An elevator without machine room means an elevator in which there is no separate machine room for the hoisting machine and control apparatus, but instead the hoisting machine and usually also most of the control apparatus is disposed in the elevator hoistway.

In FIG. 1 the control panel 1 is fitted into a frame 14 of an entrance door 15 of the elevator hoistway on a landing outside the elevator hoistway. The control panel 1 is provided with a turning door, which for the sake of clarity is not presented in FIG. 1. The base plate 7, side walls 8, 9 and turning door of the control panel together bound an enclosed space, into which are fitted the manually-operated (i.e. closable and openable by hand) main switch 5 of the elevator as well as also the control cards of the elevator, such as the manual emergency drive terminal 16 of the elevator, the controller 17 of the safety circuit of an elevator, and also the AC/DC power source 18, which makes the 230 volt mains voltage into 24 volt direct-current voltage for the operating voltage of the control devices of the elevator. Other components, such as an accumulator for the emergency drive device of the elevator or a movement control device for the elevator car, can also be inside the control panel 1. The turning door is provided with a lock, with which the access of unauthorized persons to components in the control panel is prevented. Servicemen, testing personnel and other such persons who use the components 5, 16, 17 in the control panel 1 in connection with the servicing, installation and testing of the elevator have a key to the turning door.

The control panel 1 has a connector 2, to which the cables of the main supply 19 of the elevator are connected. The cables 4 of the main circuit of the elevator are taken from the connector 2 to the terminals 10 on the input side of the main switch 5. From the main switch 5 the main circuit of the elevator continues onward to the connector 3, from which separate cables into the elevator hoistway and also into the elevator car leave. Via the main switch 5 of the elevator, operating electricity is supplied to the electrical devices 20 of the elevator that are in the elevator hoistway and in the car. The electrical devices 20 of the elevator are de-energized by disconnecting the current of the main circuit manually at the main switch 5. The electrical devices 20 are also energized by connecting at the main switch 5.

Also an AC/DC power source 18 as well as control cards 16, 17 for the elevator are connected to the output side of the main switch 5 in such a way that their current supply disconnects when the main switch 5 is opened.

The elevator of FIG. 1 is a high-powered elevator having a maximum load of the elevator car of 2000 kg and a maximum speed of the elevator car of 2.5 m/s. The size of the main fuses of this type of elevator is 50 A, in which case owing to the large current also the cross-sectional area of the supply cables of the main circuit of the elevator is 25 mm². The minimum permitted bending radius for these types of conductors in an elevator installation is at most 78.4 mm, which makes the placement of the main circuit supply cables 4, 4′ and the main contactor 5 in the control panel 1 more difficult.

Owing to the space problem of the main switch 5 and main circuit supply cables 4, 4′, the output side of the main switch 5 has a bent busbar 6 connected in series in each of the three phases of the main circuit, which busbar passes around the main switch 5 from the output side from under the main switch 5 back to the input side of the main switch 5. Separate main circuit cables 4′ leave from the busbars 6 onwards to the connector 3. By means of the busbars 6 it has been possible to turn the current path of the main circuit of the elevator in the control panel 180 degrees in an extremely small space in such a way that the cables 4 of the main circuit of the elevator arriving 4 at the main switch 5 as well as the cables 4′ of the main circuit of the elevator that continue onwards from the busbar 6 to the connector 3 are situated in the control panel on the same side of the main switch 5. Owing to this the incoming 4 and outgoing 4′ main circuit cables travel close to each other in the control panel and also arrive at and leave from the same point of the control panel 1, in which case surplus current coils causing electromagnet interference are not formed from the main circuit cabling 4, 4′.

Owing to the series circuit of the main switch 5 and the busbar 6, it has also been possible to make the control panel elongated, in which case it has been possible to fit it into the frame of a hoistway door. According to FIG. 1 the main switch 5 could be situated in the control panel 1 at a normal usage height in the top part of the control panel 1. The connectors 2, 3 are situated at the bottom in connection with the short side wall 8 of the control panel, to which connectors it is easy to connect the incoming cables of the main supply 19 of the elevator as well as the outgoing cables 20 of the electrical devices 20 of the elevator without extra wall installations.

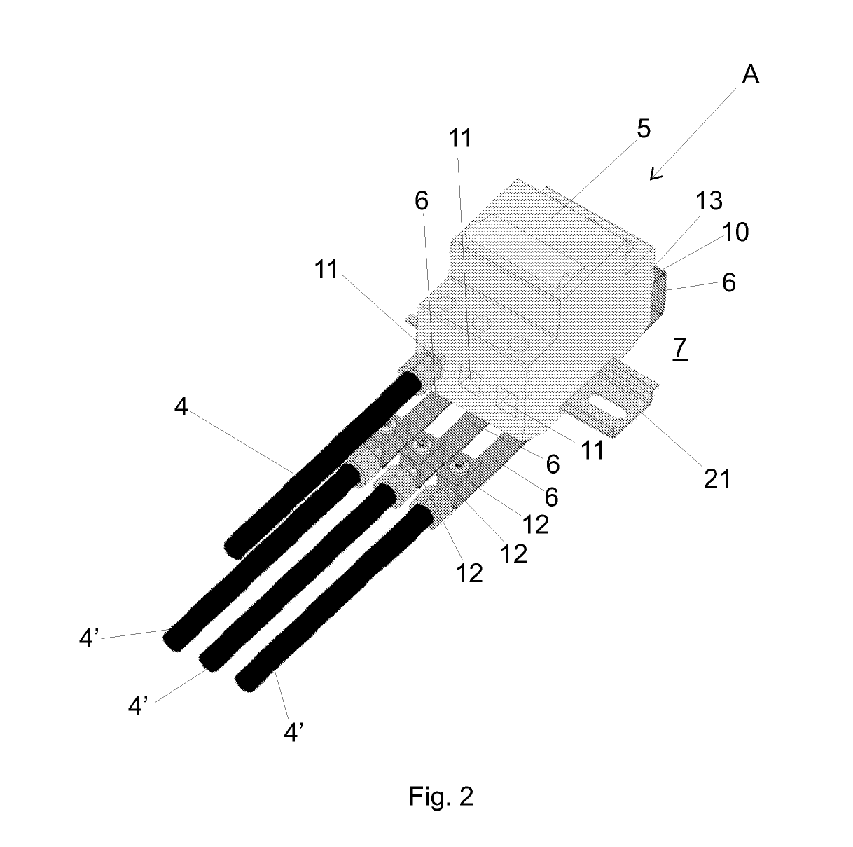

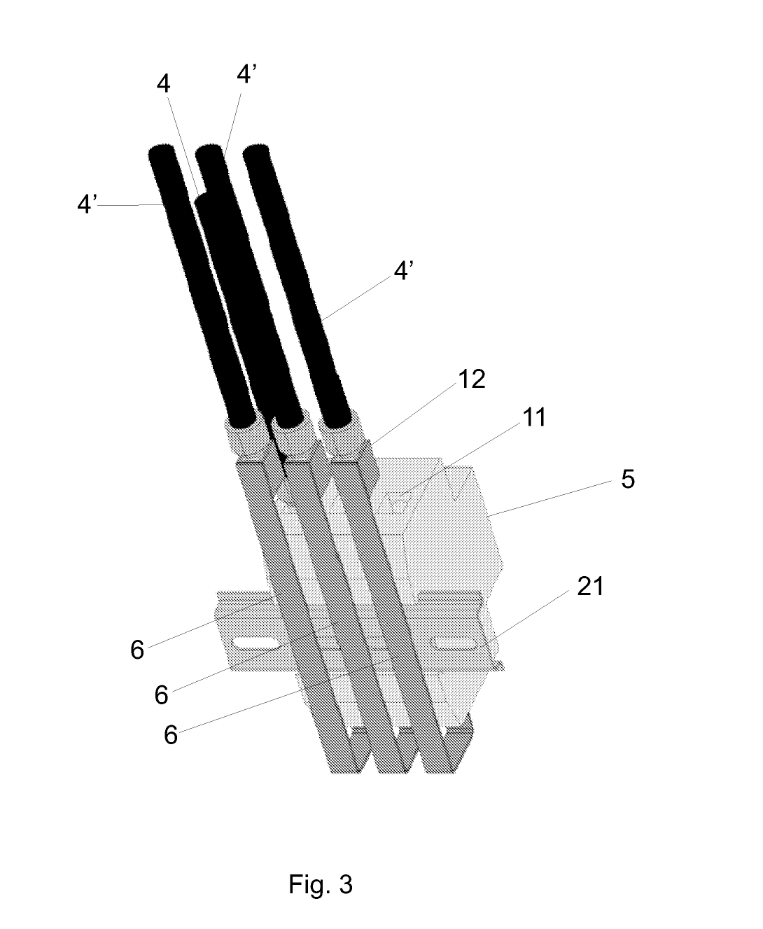

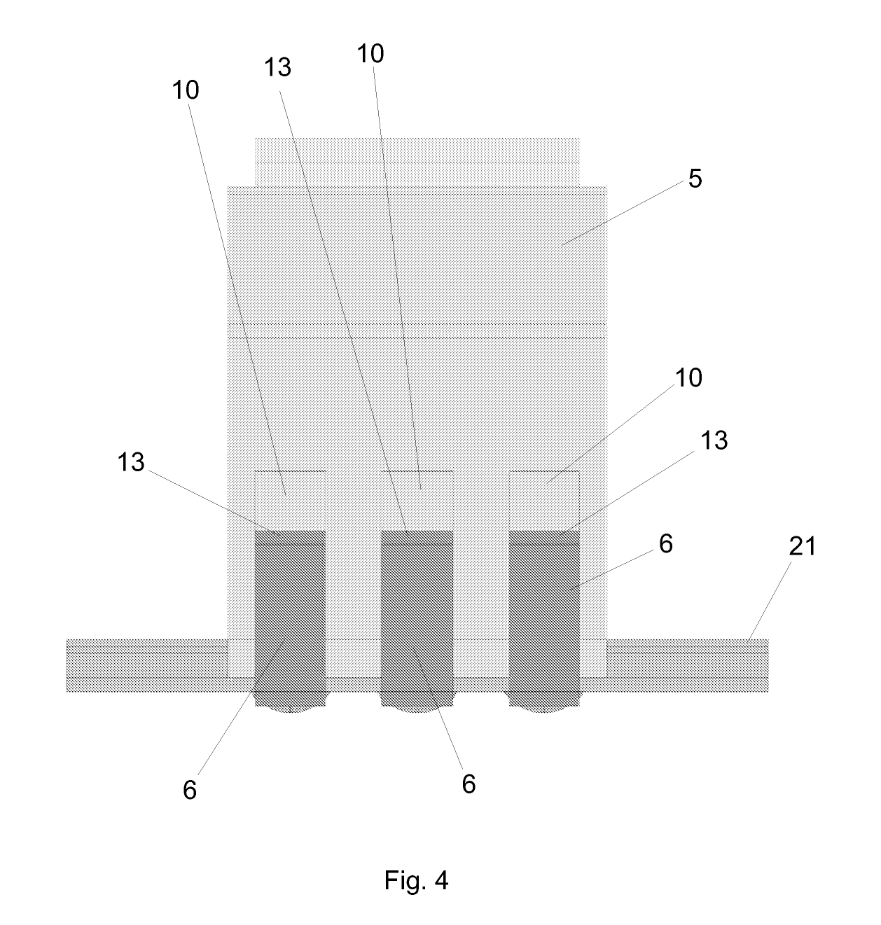

FIG. 2 presents in more detail an oblique top view of the series circuit of the main switch 5 and the busbars 6 in the control panel of FIG. 1. FIG. 3 presents an oblique bottom view of the series circuit of FIG. 2. FIG. 4 presents the series circuit of FIGS. 2 and 3 as viewed from the direction A marked in FIG. 2. The main switch 5 is fixed to the base plate 7 of the control panel with an installation rail 21. The main switch 5 and the busbars 6 have connection terminals 10, 11, 12, 13. The connection terminals 10 of the output side of the main switch 5 are connected to the connection terminals 13 of the input side of the busbars 6. A separate busbar 6 is connected to each connection terminal 10 of the output side of the main switch 5 in such a way that the busbars are situated in three different phases of the main circuit. Each busbar 6 is bent to travel under the main switch 5 in such a way that the connection terminal 12 of the output side of a busbar 6 is disposed on the same side of the main switch 5 as the connection terminals 11 of the input side of the main switch. The cables of the incoming main circuit 4 are connected to the connection terminals 11 of the input side of the main switch, and the cables of the outgoing main circuit 4′ are connected to the connection terminals 12 of the output side of the busbars 6. For the sake of clarity, only one cable 4 of the incoming main circuit is presented in FIGS. 2 and 3. The busbars 6 are coated with plastic electrical insulation, which is laminated onto the surface of the busbar 6. The cables of the incoming main circuit 4 and the cables of the outgoing main circuit 4′ are disposed one above the other on the base 7 of the control panel.

It is obvious to the person skilled in the art that a busbar 6 can be shaped in many different ways for achieving the desired space-efficiency, taking into account, inter alia, the shape and structure of the control panel 1.

In the embodiments described above the main circuit 4, 4′ is a three-phase AC voltage circuit. It is, however, obvious to a person skilled in the art that the main circuit can also be e.g. a single-phase AC voltage circuit or a DC voltage circuit.

It is further obvious to the person skilled in the art that the wiring of e.g. the earth conductors and neutral conductors, in addition to the wiring of the phase conductors, can be implemented in the control panel 1 using a busbar 6 according to the invention.

It is further obvious to the person skilled in the art that a busbar 6 connected in series can be integrated as a part of the main switch 5.

The invention is not only limited to be applied to the embodiments described above, but instead many variations are possible within the scope of the inventive concept defined by the claims.

1. A control panel of an elevator, comprising:
an input, via which the main circuit of the elevator is brought to the control panel;
an output, via which the main circuit of the elevator is taken onwards out of the control panel; and
a main switch, which is connected to the main circuit of the elevator for disconnecting/energizing the main circuit leaving from the control panel; and
a bent busbar, which is connected to the main circuit of the elevator, in series with the main switch,
wherein the control panel is elongated, comprising a base as well as two shorter and two longer side walls facing each other, and wherein the input and the output of the main circuit of the elevator are situated on the same shorter side wall of the control panel.

2. The control panel according to claim 1, wherein the busbar is configured to turn the current path of the main circuit of the elevator 180 degrees in the control panel.

3. The control panel according to claim 1, wherein the busbar is coated with electrical insulation.

4. The control panel according to claim 3, wherein the electrical insulation is laminated onto the surface of the busbar.

5. The control panel according to claim 1, wherein the cables of the incoming main circuit and the cables of the outgoing main circuit are disposed one above the other on the base of the control panel.

6. The control panel according to claim 1, wherein the control panel has an openable lid, via which the main switch can be accessed.

7. The control panel according to claim 1, wherein the control panel has a separate busbar per each phase of the main circuit of the elevator, and wherein each busbar is connected, in series with the main switch, to a different phase of the main circuit of the elevator.

8. The control panel according to claim 7, wherein both the main switch and the busbars have connection terminals wherein each connection terminal of the output side of the main switch is connected to the connection terminal of the input side of the busbar, and wherein the busbar is bent to travel under the main switch in such a way that the connection terminal of the output side of each busbar is disposed on the same side of the main switch 0 as the connection terminals of the input side of the main switch.

9. Control The control panel according to claim 8, wherein the cables of the main circuit arriving in the control panel are connected to the connection terminals of the input side of the main switch; switch, and wherein the cables of the main circuit leaving the control panel are connected to the connection terminals of the output side of the busbars.

10. An elevator, wherein the elevator system comprises the control panel according to claim 1.

11. The elevator according to claim 10, wherein the elevator is an elevator without machine room.

12. The elevator according to claim 10, wherein the control panel is fitted into the frame of a door of the elevator hoistway or in the immediate proximity of said frame.

13. The control panel according to claim 2, wherein the busbar is coated with electrical insulation.

14. The control panel according to claim 2, wherein the cables of the incoming main circuit and the cables of the outgoing main circuit are disposed one above the other on the base of the control panel.

15. The control panel according to claim 3, wherein the cables of the incoming main circuit and the cables of the outgoing main circuit are disposed one above the other on the base of the control panel.

16. The control panel according to claim 4, wherein the cables of the incoming main circuit and the cables of the outgoing main circuit are disposed one above the other on the base of the control panel.

17. The control panel according to claim 2, wherein the control panel has an openable lid, via which the main switch can be accessed.

18. The control panel according to claim 3, wherein the control panel has an openable lid, via which the main switch can be accessed.

19. The control panel according to claim 4, wherein the control panel has an openable lid, via which the main switch can be accessed.

20. The control panel according to claim 5, wherein the control panel has an openable lid, via which the main switch can be accessed.
